(19) United States
(12) Patent Application Publication
(10) Pub. No.: US 2010/0246978 A1
(43) Pub. Date: Sep. 30, 2010

(54) DATA VERIFICATION METHOD, DATA VERIFICATION DEVICE, AND DATA VERIFICATION PROGRAM

(75) Inventor: Jun MAKIHARA, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Shin-Yokohama (JP)

(21) Appl. No.: 12/750,102

(22) Filed: Mar. 30, 2010

(30) Foreign Application Priority Data
Mar. 31, 2009 (JP) 2009-87861

(51) Int. Cl. G06K 9/68

(52) U.S. Cl. 382/218

(57) ABSTRACT

A data verification method includes extracting a first graphic and a second graphic from a first circuit pattern, extracting a third graphic and a fourth graphic from a second circuit pattern, the second circuit pattern being in a layer different than a layer including the first circuit pattern; performing transformation on the first graphic; comparing the first graphic having undergone the transformation with the second graphic; performing the transformation on the third graphic; comparing the third graphic having undergone the transformation with the fourth graphic; when the first graphic having undergone the transformation matches the second graphic, and the third graphic having undergone the transformation matches the fourth graphic, performing grouping for the first and second graphics and setting the first graphic as a first representative graphic; and verifying a shape of the first circuit pattern based on the first representative graphic.

### CROSS-REFERENCE TO RELATED APPLICATION

This application is based upon and claims the benefit of priority of the prior Japanese Patent Application No. 2009-087861, filed on Mar. 31, 2009, the entire contents of which are incorporated herein by reference.

### FIELD

The embodiments discussed herein relate to a data verification method, a data verification device, and a data verification program.

### BACKGROUND

Recent large scale integrated (LSI) circuits have finer configurations than those of former LSI circuits. Due to such finer configurations, Optical Proximity Correction (OPC) has become more and more complicated. Generally, mask data is verified in light of actual conditions of the complicated OPC. For example, Japanese Patent Application Laid-Open Publication No. 2007-266391 discusses a method that includes dividing a region to be verified into smaller regions; comparing a target pattern with a pattern to be checked in each of the smaller regions; extracting a coordinate value corresponding to a danger point at which a difference between the shape of the target pattern and the shape of the pattern to be checked exceeds a first allowable value; deleting coordinate values corresponding to peripheries of the smaller regions from the coordinate values corresponding to the extracted danger points; generating a dangerous pattern based on a remaining coordinate value that corresponds to the danger point and cutting out the dangerous pattern from the target pattern; and extracting a dangerous pattern different from the other dangerous patterns as a representative pattern.

When the shapes of mutually related circuit patterns in two or more layers are verified, it is difficult to reflect the relationships among the layers in the verification. For example, in an LSI circuit, a contact layer is coupled to another layer, such as a wiring layer, an electrode layer, or a diffusion layer. When mask data for the contact layer is verified, the shape of the layer to which the contact layer is coupled remains undetermined even after the contact layer undergoes an exposure simulation. Even when the exposure simulation provides preferable results for the contact layer, poor coupling may be caused depending on the shape that the layer to which the contact layer is coupled, such as the wiring layer, has after the exposure simulation.

In addition, even when different regions of the contact layer have a same circuit pattern, corresponding regions of another layer to which the contact layer is coupled, such as the wiring layer, may have different circuit patterns. Since the corresponding regions of the layer to which the contact layer is coupled are affected differently by the OPC, the exposure simulation may cause some regions to be coupled in a preferable coupling state while causing the other regions to be coupled in a poor coupling state.

### SUMMARY

According to an aspect of the embodiment, a data verification method includes extracting a first graphic included in a first reference frame set to correspond to a reference coordinate, and extracting a second graphic included in a second reference frame set to correspond to the reference coordinate from a first circuit pattern; extracting a third graphic included in the first reference frame and a fourth graphic included in the second reference frame from a second circuit pattern, the second circuit pattern being in a layer different than a layer including the first circuit pattern; performing coordinate transformation on the first graphic; comparing the first graphic having undergone the coordinate transformation with the second graphic; performing the coordinate transformation on the third graphic; comparing the third graphic having undergone the coordinate transformation with the fourth graphic; when matching of the first graphic having undergone the coordinate transformation and the second graphic is determined, and matching of the third graphic having undergone the coordinate transformation and the fourth graphic is determined, performing grouping for the first and second graphics and setting the first graphic as a first representative graphic; and verifying a shape of the first circuit pattern based on the first representative graphic.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating Embodiment 1;

FIG. 2 is a flowchart illustrating Embodiment 1 in FIG. 1;

FIG. 3 illustrates a configuration according to Embodiment 2;

FIG. 4 is a block diagram illustrating Embodiment 2 in FIG. 3;

FIG. 5 is a flowchart illustrating Embodiment 2 in FIG. 3;

FIG. 6 is a flowchart illustrating Embodiment 2 in FIG. 3;

FIG. 7 is a flowchart illustrating Embodiment 2 in FIG. 3;

FIG. 8 is a flowchart illustrating Embodiment 2 in FIG. 3;

FIG. 9 is a flowchart illustrating Embodiment 2 in FIG. 3;

FIG. 10 is a flowchart illustrating Embodiment 2 in FIG. 3;

FIG. 11 illustrates an example according to Embodiment 2 in FIG. 3;

FIG. 12 illustrates the example in FIG. 11;

FIG. 13 illustrates the example in FIG. 11;

FIG. 14 illustrates an example according to Embodiment 2 in FIG. 3;

FIG. 15 illustrates the example in FIG. 14;

FIG. 16 is a flowchart illustrating Embodiment 3;

FIG. 17 illustrates an example according to Embodiment 3 in FIG. 16; and

FIG. 18 illustrates the example in FIG. 17.

### DESCRIPTION OF EMBODIMENTS

Embodiments of a data verification method, a data verification device, and a data verification program are described in detail below with reference to the accompanying drawings.

A configuration of a data verification device 1 according to Embodiment 1 is described below.

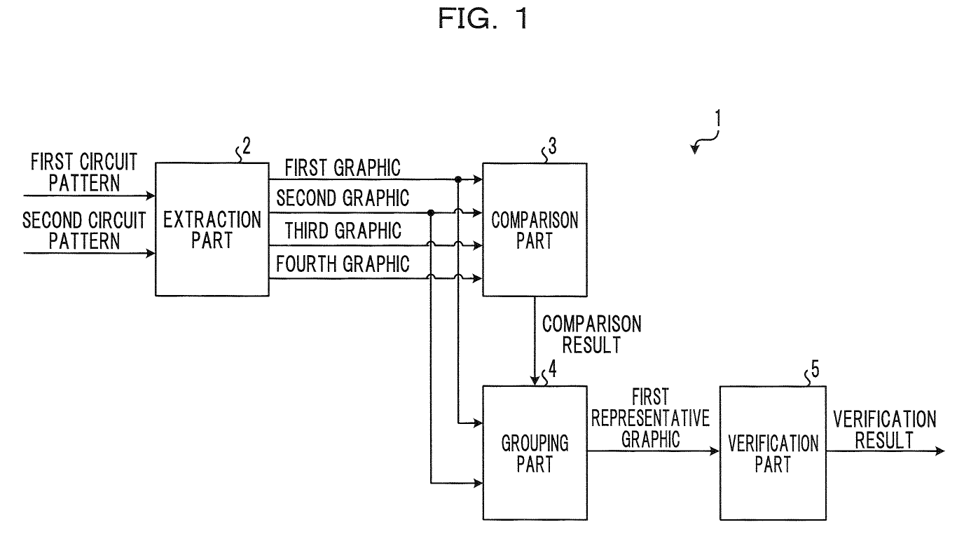

FIG. 1 is a block diagram illustrating Embodiment 1. As illustrated in FIG. 1, the data verification device 1 verifies a shape of a circuit pattern in an electronic circuit, such as a large scale integrated (LSI) circuit. In Embodiment 1, when a graphic included in a first reference frame and a graphic included in a second reference frame are substantially identical, and the first and second reference frames are included in circuit patterns in layers located at different levels, verification may be performed in light of relationships among the layers by setting the graphic in the first reference frame as a representative graphic.

The data verification device 1 includes an extraction part 2, a comparison part 3, a grouping part 4, and a verification part 5. The extraction part 2 extracts a first graphic and a second graphic from a first circuit pattern and extracts a third graphic and a fourth graphic from a second circuit pattern. The first and second circuit patterns are provided in layers located at different levels. The first and third graphics are included in a first reference frame set based on a reference coordinate. The second and fourth graphic are included in a second reference frame set based on the reference coordinate.

The comparison part 3 transforms the coordinates of the first graphic and compares the resultant graphic with the second graphic. Similarly, the comparison part 3 transforms the coordinates of the third graphic and compares the resultant graphic with the fourth graphic. The coordinate transformation for the first graphic and the coordinate transformation for the third graphic are substantially the same. Based on the comparison results obtained by the comparison part 3, the grouping part 4 performs grouping for the first graphic and the second graphic and sets the first graphic as a first representative graphic. Conditions for the grouping are that the first graphic and the second graphic are determined to be substantially identical and that the third graphic and the fourth graphic are determined to be substantially identical. The verification part 5 verifies a shape of the first circuit pattern based on the first representative graphic.

Operations of the data verification device 1 according to Embodiment 1 are described below.

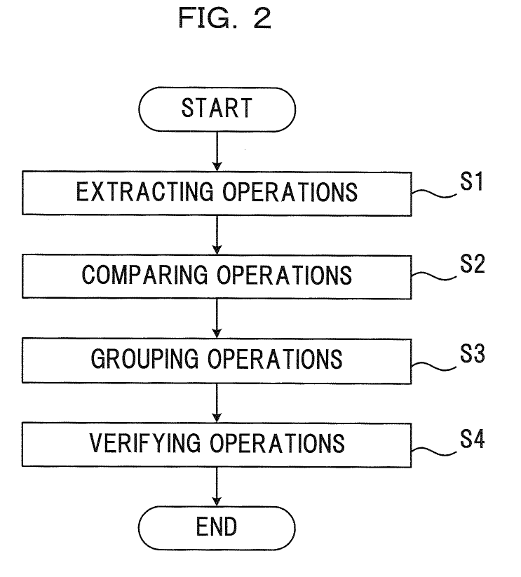

FIG. 2 is a flowchart illustrating Embodiment 1. As illustrated in FIG. 2, when the data verifying operations start, the extraction part 2 extracts the first graphic, which is included in the first reference frame set based on the reference coordinate, and the second graphic, which is included in the second reference frame set based on the reference coordinate, from the first circuit pattern. The extraction part 2 further extracts the third graphic, which is included in the first reference frame, and the fourth graphic, which is included in the second reference frame, from the second circuit pattern provided in a layer higher or lower than the layer including the first circuit pattern (Operation S1).

The comparison part 3 transforms the coordinates of the first graphic and compares the resultant graphic with the second graphic. Similarly, the comparison part 3 transforms the coordinates of the third graphic and compares the resultant graphic with the fourth graphic (Operation S2). When the comparison part 3 determines that the first graphic is substantially identical with the second graphic and the third graphic is substantially identical with the fourth graphic, the grouping part 4 performs the grouping for the first graphic and the second graphic and sets the first graphic as the first representative graphic (Operation S3). The verification part 5 verifies the shape of the first circuit pattern based on the first representative graphic (Operation S4).

According to Embodiment 1, when circuit patterns in different layers are mutually related, graphics included in a same reference frame set for the layers may be classified as a unit and the classified units may be grouped based on statuses of the units. That is, shapes of circuit patterns in two or more layers may be verified even when the circuit patterns are mutually related.

A hardware configuration of a data verification device 31 according to Embodiment 2 is described below.

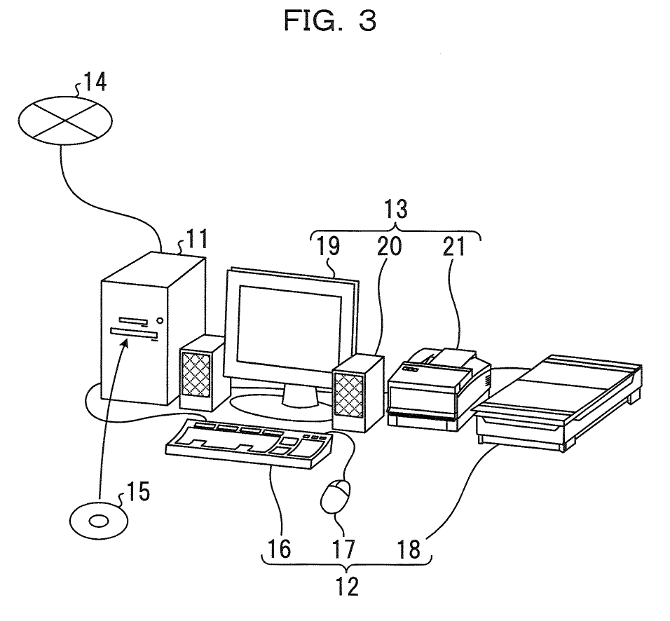

FIG. 3 illustrates the hardware configuration. As illustrated in FIG. 3, the data verification device 31 may include a main computer unit 11, an input unit 12, and an output unit 13 for example. The data verification device 31 may be coupled to a network 14, such as a Local Area Network (LAN), a Wide Area Network (WAN), or the Internet, through a router (not depicted) or a modem (not depicted) for example.

For example, the main computer unit 11 includes a Central Processing Unit (CPU), a memory, and an interface, which are not depicted. The CPU is responsible for controlling the overall data verification device 31. Examples of the memory include a Read Only Memory (ROM), a Random Access Memory (RAM), a Hard Disk (HD), and an optical disk 15. The memory is used as a work area for the CPU and stores various programs. Each of the programs is loaded in response to a command from the CPU.

For example, the interface controls an input from the input unit 12, an output to the output unit 13, and transmission and reception through the network 14. For example, the input unit 12 includes a keyboard 16, a mouse 17, and a scanner 18. For example, the output unit 13 includes a display 19, a speaker 20, and a printer 21.

A detailed configuration of the data verification device 31 according to Embodiment 2 is described below.

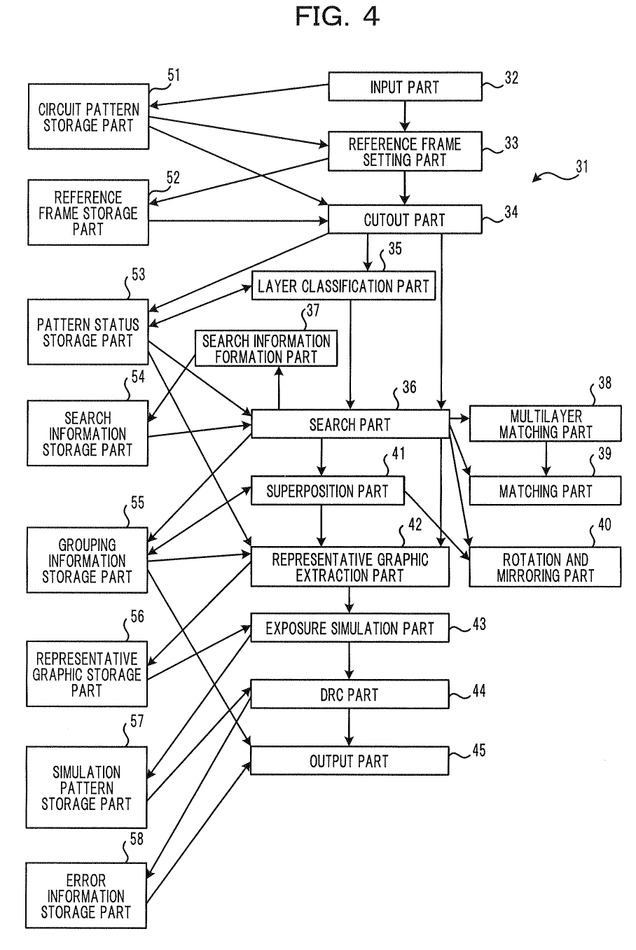

FIG. 4 is a block diagram illustrating Embodiment 2. Referring to FIG. 4, the data verification device 31 includes an input part 32, a reference frame setting part 33, and a cutout part 34. The input part 32 reads a circuit pattern in a target layer to be verified and a circuit pattern in another layer related (for example, coupled) to the target layer from design data stored in the memory, such as mask data. The input part 32 stores the read circuit patterns in a circuit pattern storage part 51.

The reference frame setting part 33 reads the circuit pattern in the target layer from the circuit pattern storage part 51 and sets a reference frame for the read circuit pattern. The reference frame for the circuit pattern in the target layer is set to include a target graphic to be verified and is set to be in a region where lithographic Design Rule Check (DRC) may have an effect on the target graphic. For example, the lithographic DRC checks dimensions of a shape of a wafer image, such as a line width and a space between lines. The shape of the wafer image is calculated by an exposure simulation based on the mask data. For example, the reference frame setting part 33 stores a coordinate value corresponding to the reference frame in a reference frame storage part 52. The coordinate value is set based on a reference coordinate. The reference coordinate is shared by the circuit pattern in the target layer and the circuit pattern in the other layer.

The cutout part 34 reads the circuit pattern in the target layer and the circuit pattern in the other layer from the circuit pattern storage part 51. The cutout part 34 reads the stored reference frame from the reference frame storage part 52. The cutout part 34 extracts a graphic included in the region in the read reference frame from the read circuit pattern in the target layer and stores the extracted graphic in a pattern status storage part 53 as a pattern status. In addition, the cutout part 34 extracts a graphic included in the region in the read reference frame from the read circuit pattern in the other layer and stores the extracted graphic in the pattern status storage part 53 as the pattern status. The input part 32, the reference frame setting part 33, and the cutout part 34 operate as, for example, an extraction part.

The data verification device 31 includes a layer classification part 35, a search part 36, a search information formation part 37, a multilayer matching part 38, a matching part 39, and a rotation and mirroring part 40. The layer classification part 35 reads the pattern status from the pattern status storage part 53 and classifies the read pattern statuses for each layer. The layer classification part 35 stores the classified pattern statuses in the pattern status storage part 53, for each layer.

The search part 36 reads the pattern status from the pattern status storage part 53 and searches a search information storage part 54 for search information that matches the pattern status. The search information may include, for example, information on the pattern status, such as “the number of layers,” “a layer type,” “the number of graphics of each layer,” “the number of coordinates of each graphic,” “coordinate values of each graphic,” and “matching pattern statuses.” The search part 36 stores grouping information for grouping the matching pattern statuses under classes in a grouping information storage part 55.

When search information that matches the pattern status is found in the searching operations by the search part 36, the search information formation part 37 adds the pattern status to “the matching pattern statuses” of the search information. When no search information that matches the pattern status is found in the searching operations, the search information formation part 37 registers the pattern status as new search information. The search information formation part 37 stores the resulting search information in the search information storage part 54.

When the search part 36 performs the searching operations, the multilayer matching part 38 performs matching operations and checks “the number of layers” and “the layer type” of the pattern status, and “the number of layers” and “the layer type” of the search information. The multilayer matching part 38 determines a matching or mismatching result. The matching part 39 checks “the number of graphics,” “the number of coordinates,” and “the coordinate values” of the pattern status, and “the number of graphics,” “the number of coordinates,” and “the coordinate values” of the search information in matching operations performed while the search part 36 performs the searching operations. The matching part 39 determines a matching or mismatching result. The rotation and mirroring part 40 performs rotation or mirroring, or both the rotation and the mirroring for the pattern statuses stored in the pattern status storage part 53.

For example, the rotation includes rotating coordinate values of an original pattern status by a given angle of 90°, 180°, or 270° around a given point, such as the center of a reference frame of the original pattern status to obtain the resultant coordinate values. For example, the mirroring includes calculating coordinate values symmetrical to coordinate values of an original pattern status about a given straight line, such as a straight line that passes through the center of the reference frame of the original pattern status and is parallel to a coordinate axis. In coordinate transforming operations, a superposition part 41 superposes graphics included in a region in the same reference frame set for layers. That is, the graphics included in the region in the same reference frame set for the layers may undergo the same coordinate transforming operations. The contents of the coordinate transforming operations are stored in the grouping information storage part 55 as part of the grouping information. The layer classification part 35, the search part 36, the search information formation part 37, the multilayer matching part 38, the matching part 39, and the rotation and mirroring part 40 operate, for example, as a comparison part. The superposition part 41 operates as, for example, a combining part.

The data verification device 31 includes the superposition part 41 and a representative graphic extraction part 42. The superposition part 41 reads the grouping information from the grouping information storage part 55 and, based on the read grouping information, superposes the graphics included in the region in the same reference frame set for the layers. The superposition part 41 stores the superposed grouping information in the grouping information storage part 55.

The representative graphic extraction part 42 reads the pattern status from the pattern status storage part 53. The representative graphic extraction part 42 reads the grouping information from the grouping information storage part 55. The representative graphic extraction part 42 extracts a representative graphic of each class based on the read pattern status and the read grouping information. The representative graphic extraction part 42 stores the extracted representative graphic in a representative graphic storage part 56. The superposition part 41 and the representative graphic extraction part 42 operate as, for example, a grouping part.

The data verification device 31 includes an exposure simulation part 43, a DRC part 44, and an output part 45. The exposure simulation part 43 reads the representative graphic from the representative graphic storage part 56 and performs an exposure simulation on the read representative graphic. The exposure simulation part 43 stores a simulation pattern obtained by the exposure simulation in a simulation pattern storage part 57.

The DRC part 44 reads the simulation pattern from the simulation pattern storage part 57 and performs verification on the read simulation pattern using the DRC. The DRC part 44 stores information regarding a portion that fails to satisfy the design rule as a result of the verification in an error information storage part 58 as error information.

The output part 45 reads the grouping information from the grouping information storage part 55. The output part 45 reads the error information from the error information storage part 58. Based on the read grouping information and the read error information, the output part 45 identifies a portion of the original circuit pattern that corresponds to the portion included in the representative graphic and fails to satisfy the design rule. The output part 45 outputs the portion, which is included in the original circuit pattern and fails to satisfy the design rule, to an output device, such as a display or a printer. The exposure simulation part 43, the DRC part 44, and the output part 45 operate as, for example, a verification part.

Operations of the data verification device 31 are described below.

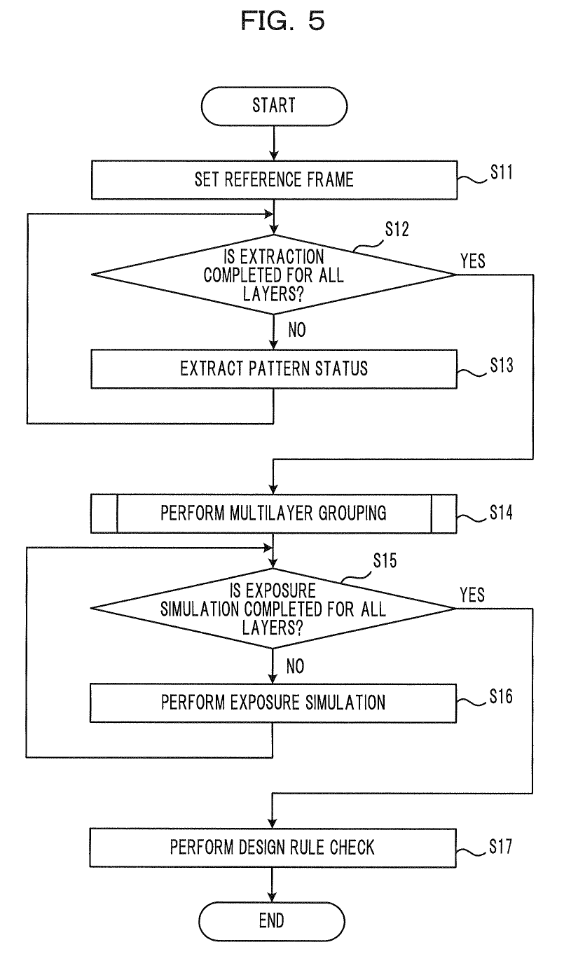

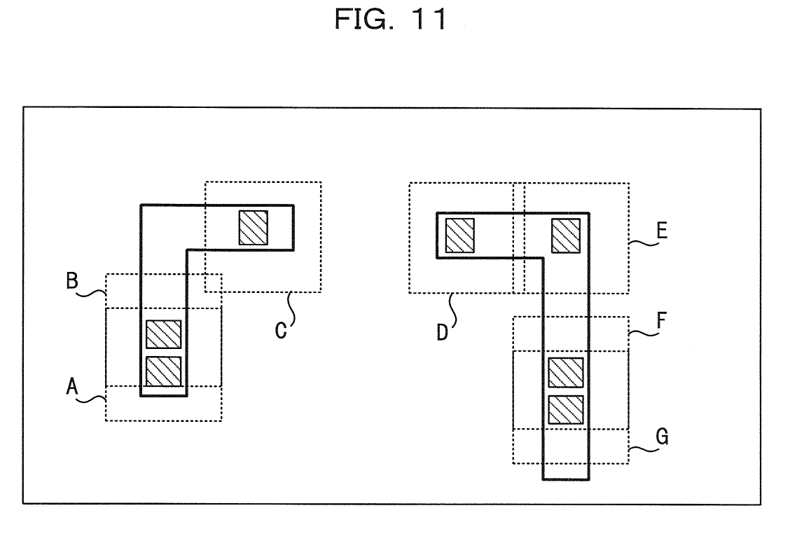

FIGS. 5 to 10 are flowcharts illustrating Embodiment 2. FIGS. 11 to 13 illustrate an example according to Embodiment 2. In the example, the target layer is a contact layer and the other layer related (for example, coupled) to the target layer is a wiring layer. In FIGS. 11 to 13, the rectangular frames indicated by dotted lines represent the reference frames, the shaded regions represent the contact layer, and the regions indicated by solid lines represent the wiring layer.

As illustrated in FIG. 5, when the data verifying operations start, the reference frame setting part 33 sets a reference frame for the circuit pattern in the target layer (Operation S11). The cutout part 34 extracts a graphic included in a region in the reference frame of the target layer as a pattern status and extracts a graphic included in a region in the reference frame of the other layer, which is related (for example, coupled) to the target layer, as a pattern status (Operation S13). If the extraction is uncompleted for the layers (Operation S12: No), the extraction is performed for the layer that has not yet undergone the extraction. FIG. 11 illustrates pattern statuses A to G obtained by superposing the extracted pattern statuses of the contact layer and the extracted pattern statuses of the wiring layer.

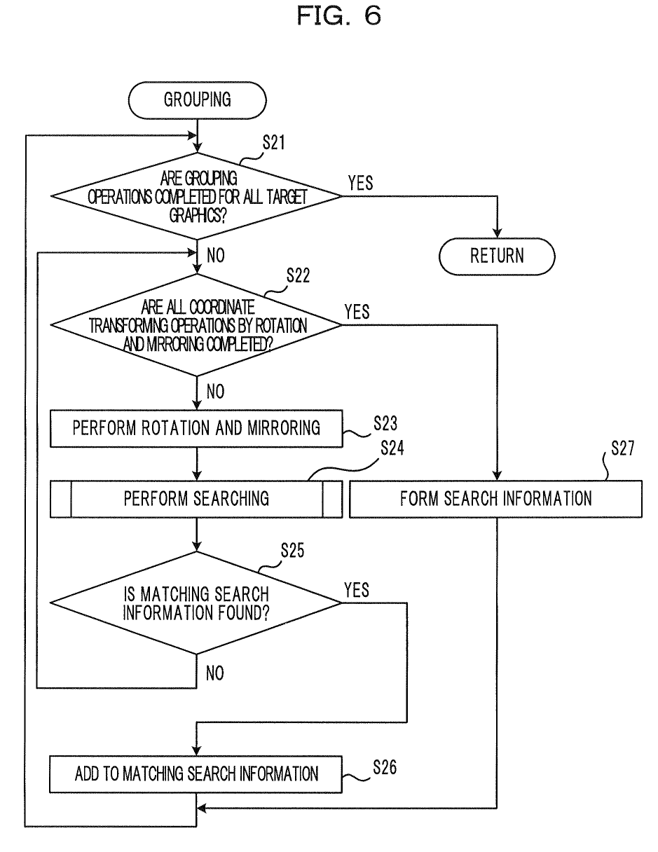

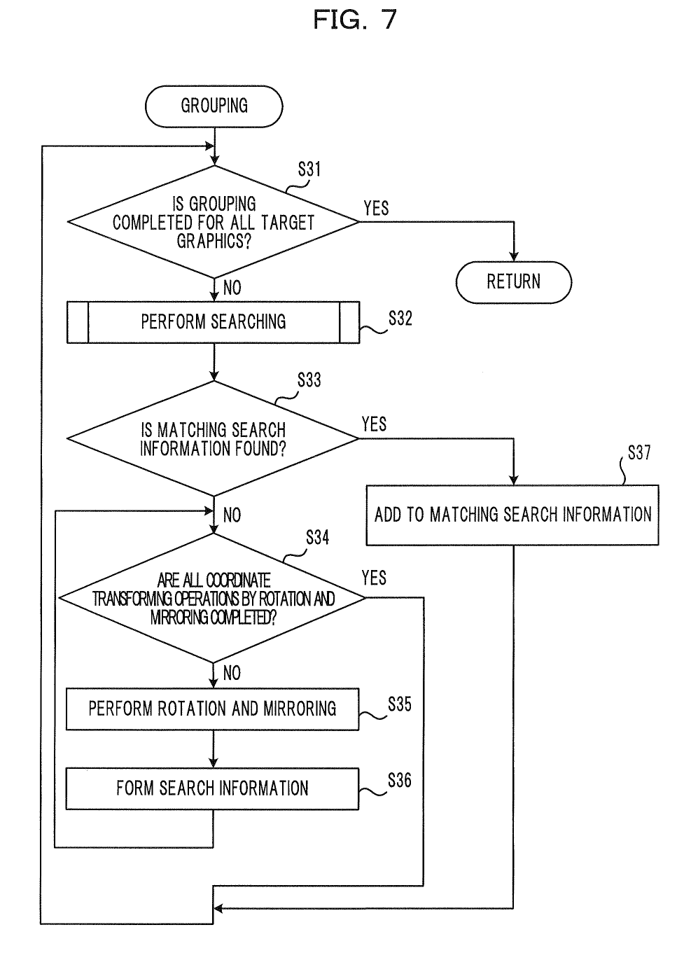

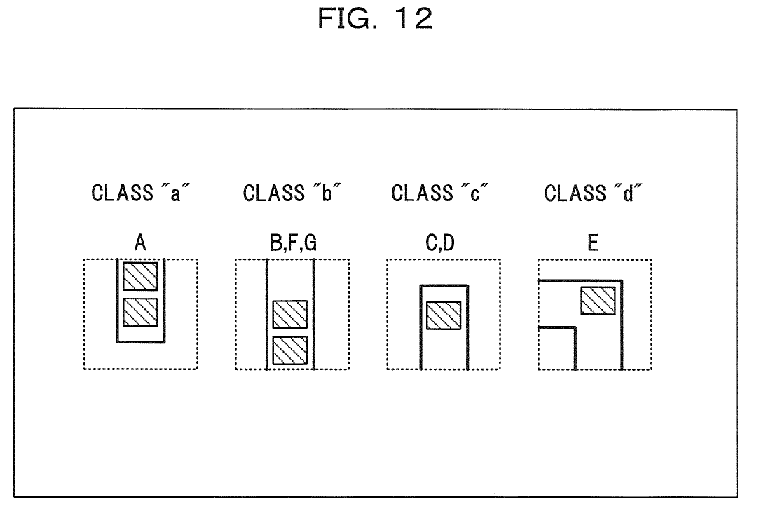

When the extraction of the pattern statuses of the target layer and the other layer related (for example, coupled) to the target layer is completed, that is, the extraction is completed for all of the layers (Operation S12: Yes), the search part 36, the search information formation part 37, the multilayer matching part 38, the matching part 39, the rotation and mirroring part 40, the superposition part 41, and the representative graphic extraction part 42 perform multilayer grouping operations (Operation S14). The multilayer grouping operations are described in detail below with reference to FIGS. 6 and 7. FIG. 12 illustrates classes “a” to “d” obtained by grouping the pattern statuses A to G in FIG. 11 in the multilayer grouping operations. For example, the representative graphic of the class “a” is the pattern status A. In the class “b,” the pattern status F is substantially the same as the pattern status B, and the pattern status G is substantially the same as the pattern status B when the pattern status B is rotated by 180°. For example, the representative graphic of the class “b” is the pattern status B. In the class “c,” the pattern status D is substantially the same as the pattern status C when the pattern status C is rotated by 180°. For example, the representative graphic of the class “c” is the pattern status C. For example, the representative graphic of the class “d” is the pattern status E.

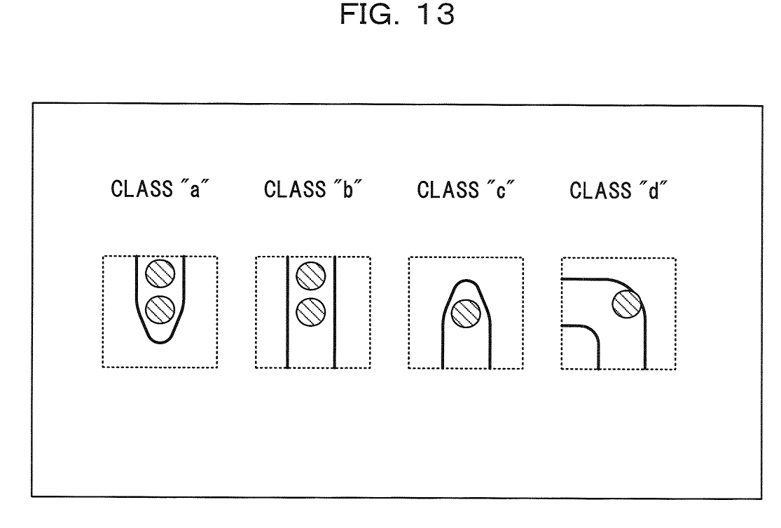

The exposure simulation part 43 performs the exposure simulations on the representative graphics of the target layer and the representative graphics of the other layer related (for example, coupled) to the target layer (Operation S16). If the exposure simulation is uncompleted for the layers (Operation S15: No), the exposure simulation is performed for the layer that has not yet undergone the exposure simulation. FIG. 13 illustrates simulation patterns obtained by superposing simulation patterns of the contact layer and simulation patterns of the wiring layer. In the example illustrated in FIG. 13, the number of exposure simulations performed for each of the representative graphics of the classes “a” to “d” of the contact layer and the wiring layers is two, that is, a total of eight-time exposure simulations are performed. When the exposure simulations are completed for the target layer and the other layer related (for example, coupled) to the target layer, that is, the exposure simulations are completed for all of the layers (Operation S15: Yes), the DRC part 44 verifies the simulation patterns using the DRC (Operation S17). The output part 45 performs coordinate reverse-transforming operations for the result of the verification so that the coordinates obtained as the result of the coordinate reverse-transforming operations, which are included in the grouping information, are reversed. Consequently, the verification result is applied to the original circuit pattern. The original circuit pattern to which the verification result has been applied is output to a display or the like, and the above operations are completed.

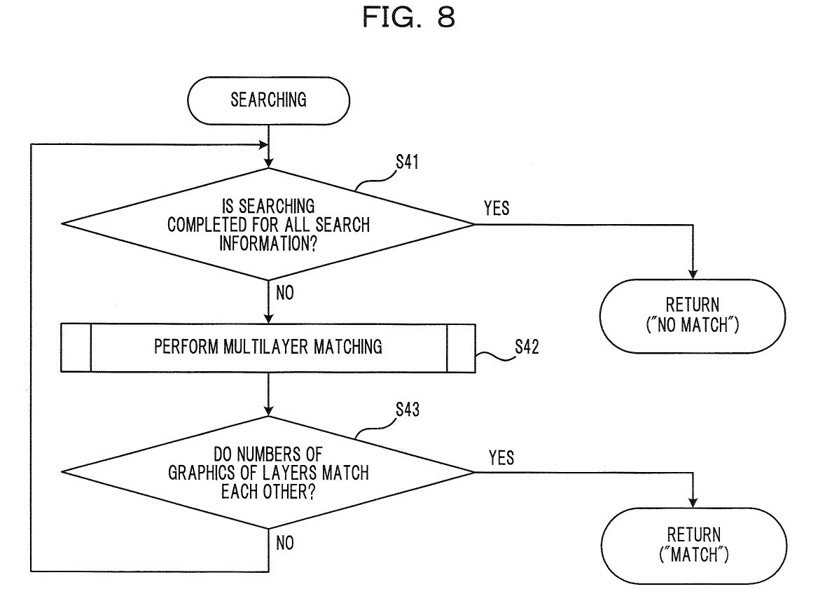

As illustrated in FIG. 6, the multilayer grouping operations start by checking whether the multilayer grouping operations are completed for all the target graphics (Operation S21). When the multilayer grouping operations are uncompleted for any of the target graphics (Operation S21: No), the multilayer grouping operations are performed for any target graphic that has not yet undergone the multilayer grouping operations. After that, it is determined whether or not all coordinate transforming operations by the rotation and the mirroring are completed for each of the target graphics (Operation S22). When the coordinate transforming operations by the rotation and the mirroring are uncompleted for any of the target graphics (Operation S22: No), the rotation and mirroring part 40 and the superposition part 41 perform the coordinate transforming operations for a pattern status corresponding to any target graphic that has not yet undergone the coordinate transforming operations (Operation S23). The search part 36, the multilayer matching part 38, and the matching part 39 perform searching operations to find search information that matches the original pattern status or the pattern status that has undergone the coordinate transforming operations (Operation S24). The searching operations are described in detail below with reference to FIG. 8.

When the search information that matches the original pattern status or the pattern status that has undergone the coordinate transforming operations is found as a result of performing Operation S24 (Operation S25: Yes), the search information formation part 37 adds the search information that matches the original pattern status or the pattern status that has undergone the coordinate transforming operations to the corresponding search information (Operation S26) and the flow returns to Operation S21. When no search information that matches the original pattern status or the pattern status that has undergone the coordinate transforming operations is found in Operation S24 (Operation S25: No), the flow returns to Operation S22. When all of the coordinate transforming operations by the rotation and the mirroring are completed (Operation S22: Yes), the search information formation part 37 forms and registers the search information about the original pattern status and the pattern status that has undergone the coordinate transforming operations (Operation S27) and the flow returns to Operation S21. When the above described operations are completed for all of the target graphics (Operation S21: Yes), the flow returns to Operation S15 in the flowchart illustrated in FIG. 5.

Alternatively, the multilayer grouping operations may be performed as described below. As illustrated in FIG. 7, when the multilayer grouping operations start, whether the multilayer grouping operations are completed for all the target graphics is checked (Operation S31). When the multilayer grouping operations are uncompleted for any of the target graphics (Operation S31: No), the multilayer grouping operations are performed for any target graphic that has not yet undergone the multilayer grouping operations. The search part 36, the multilayer matching part 38, and the matching part 39 search for search information that matches the original pattern status or the pattern status that has undergone the coordinate transforming operations (Operation S32). As mentioned above, the searching operations are described in detail below with reference to FIG. 8. When the search information that matches the original pattern status or the pattern status that has undergone the coordinate transforming operations is found as a result of performing Operation S32 (Operation S33: Yes), the search information formation part 37 adds the search information about the original pattern status and the pattern status that has undergone the coordinate transforming operations to the corresponding search information (Operation S37) and the flow returns to Operation S31.

When no search information that matches the original pattern status or the pattern status that has undergone the coordinate transforming operations is found as a result of performing Operation 32 (Operation S33: No), it is determined whether or not all coordinate transforming operations by rotation and the mirroring are completed (Operation S34). If any of the coordinate transforming operations are uncompleted (Operation S34: No), the rotation and mirroring part 40 and the superposition part 41 perform the uncompleted coordinate transforming operations for the original pattern status or the pattern status that has undergone the coordinate transforming operations (Operation S35). The search information formation part 37 forms and registers the search information about the original pattern status and the pattern status that has undergone the coordinate transforming operations (Operation S36), and the flow returns to Operation S34. When all of the coordinate transforming operations by the rotation and the mirroring are completed (Operation S34: Yes), the flow returns to Operation S31. When the above described operations are completed for all of the target graphics (Operation S31: Yes), the flow returns to Operation S15 illustrated in FIG. 5.

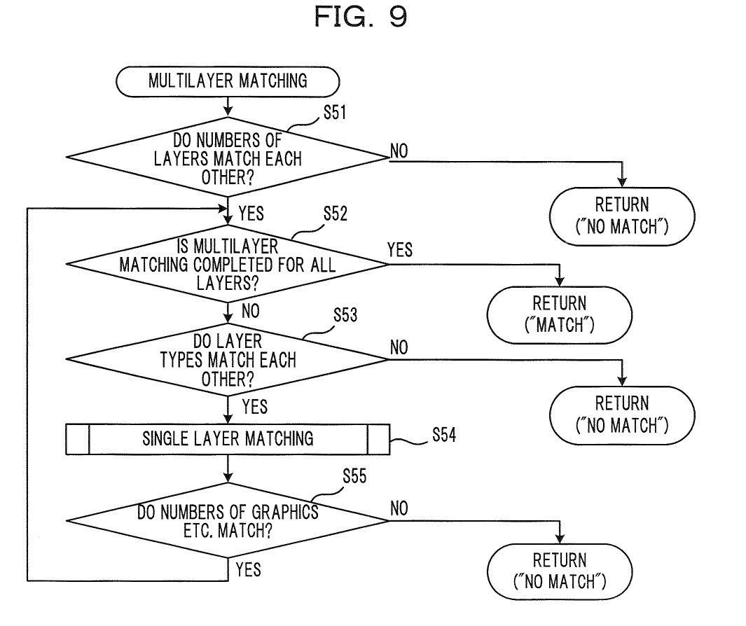

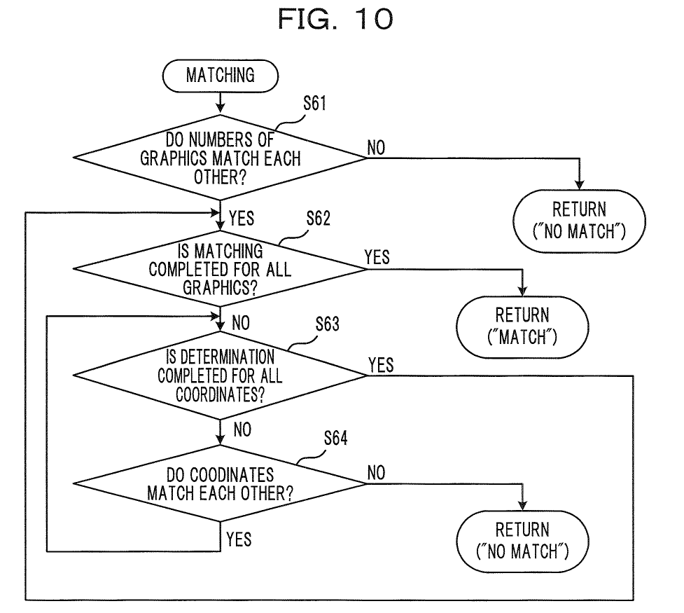

In the searching operations illustrated in FIG. 8, whether the searching operations are completed for all of the search information is checked (Operation S41). If the searching operations are uncompleted for the search information (Operation S41: No), the multilayer matching part 38 performs the matching operations for a pattern status obtained by superposing pattern statuses of two or more layers that are mutually related (Operation S42). The multilayer matching operations are described in detail below with reference to FIG. 9. When it is determined that the numbers of graphics of the layers match each other as a result of performing the multilayer matching operations (Operation S43: Yes), the result “match” is returned as a return value and the flow returns to Operation S25 illustrated in FIG. 6 or Operation S33 illustrated in FIG. 7. When it is determined that the numbers of graphics of the layers do not match each other as a result of performing the multilayer matching operations (Operation S43: No), the flow returns to Operation S41. When the above described operations are completed for all of the search information (Operation S41: Yes), the result “no match” is returned as a return value and the flow returns to Operation S25 illustrated in FIG. 6 or Operation S33 illustrated in FIG. 7. When the matching operations are performed for a pattern status of a single layer, the matching operation is performed as illustrated in FIG. 10.

As illustrated in FIG. 9, when the multilayer matching operations start, the multilayer matching part 38 checks whether the number of layers of the pattern status and the number of layers of the search information match each other (Operation S51). When the numbers of layers do not match each other (Operation S51: No), the result “no match” is returned as a return value and the flow returns to Operation S43 illustrated in FIG. 8. When the numbers of layers match each other (Operation S51: Yes), whether or not the multilayer matching operations are completed for all of the layers is checked (Operation S52). When the multilayer matching operations are uncompleted for any of the layers (Operation S52: No), it is determined whether or not the layer types of the pattern status and the search information match each other (Operation S53). When it is determined that the layer types of the pattern status and the search information do not match (Operation S53: No), the result “no match” is returned as a return value and the flow returns to Operation S43 illustrated in FIG. 8. When the layer types of the pattern status and the search information match each other (Operation S53: Yes), the matching part 39 performs the single layer matching operations for the pattern status that matches the search information in terms of the layer type. The single layer matching operations are described in detail below with reference to FIG. 10. When it is determined that the numbers of graphics and/or the like of the pattern status and the search information do not match each other as a result of performing the single layer matching operations (Operation S55: No), the result “no match” is returned as a return value and the flow returns to Operation S43 illustrated in FIG. 8. When it is determined that the numbers of graphics and/or the like of the pattern status and the search information match each other as a result of performing the single layer matching operations (Operation S55: Yes), the flow returns to Operation S52. When the above described operations are completed for all of the layers (Operation S52: Yes), the result “match” is returned as a return value and the flow returns to Operation S43 illustrated in FIG. 8.

As illustrated in FIG. 10, when the single layer matching operations start, the matching part 39 checks whether the number of graphics of the pattern status and the number of graphics of the search information match each other (Operation S61). When the numbers of graphics of the pattern status and the search information do not match each other (Operation S61: No), the result “no match” is returned as a return value and the flow returns to Operation S55 illustrated in FIG. 9. When the numbers of graphics of the pattern status and the search information match each other (Operation S61: Yes), whether or not the single layer matching operations are completed for all of the graphics is checked (Operation S62). When the single layer matching operations are uncompleted for any of the graphics (Operation S62: No), whether or not determination of the coordinates is completed for all of the graphics of the pattern status and the search information is checked (Operation S63). When the determination of the coordinates is uncompleted for any of the graphics (Operation S63: No), whether or not the coordinates of the graphics match each other is checked (Operation S64). When it is determined that the coordinates of the graphics do not match each other (Operation S64: No), the result “no match” is returned as a return value and the flow returns to Operation S55 illustrated in FIG. 9. When it is determined that the coordinates of the graphics match each other (Operation S64: Yes), the flow returns to Operation S63. When the determination is completed for all of the coordinates (Operation S63: Yes), the flow returns to Operation S62. When the above described operations are completed for all of the graphics (Operation S62: Yes), the result “match” is returned as a return value and the flow proceeds to Operation S55 illustrated in FIG. 9.

According to Embodiment 2, advantages similar to those according to Embodiment 1 may be obtained. Compared to the case where the verification is performed without grouping two or more layers having circuit patterns that are related to each other, the number of times to perform exposure simulations may be reduced. As a result, the shape obtained after the exposure simulations may be verified with reduced computer resources. In addition, the shape obtained after the exposure simulations may be verified in a shorter time. Accordingly, the lithographic DRC may be performed with higher precision when the circuit patterns in the layers are related to each other. Further, according to Embodiment 2, in addition to the shape of the contact layer obtained after the exposure simulations, a shape of a gate in a semiconductor device may be verified in view of the relationship with the wiring. Besides the shape of the gate, a shape of a portion formed by, for example, a double exposure to light, which is performed for different layers, may be verified.

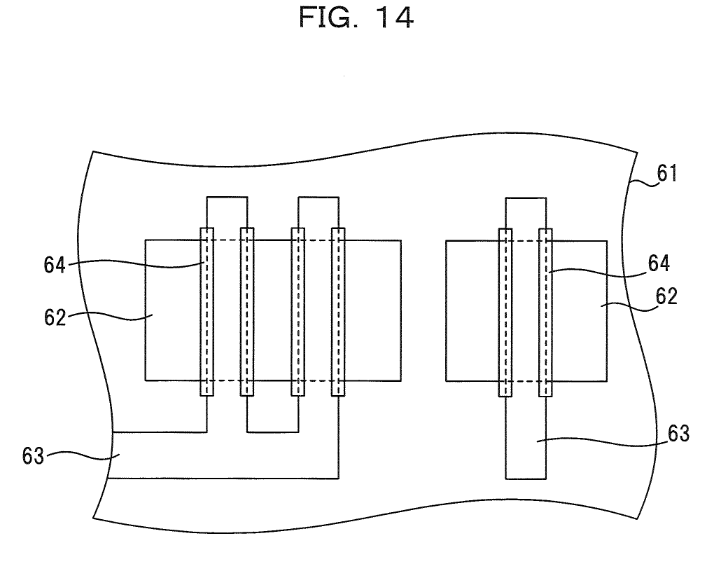

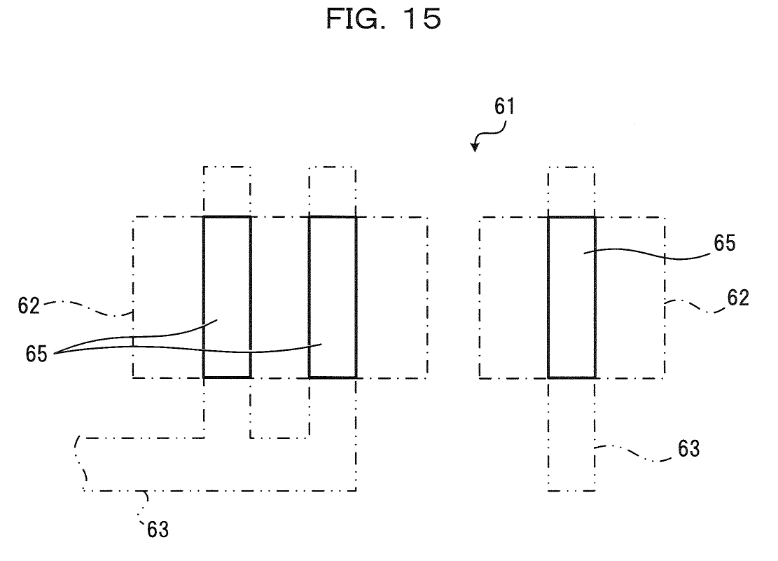

FIGS. 14 and 15 illustrate another example according to Embodiment 2. As illustrated in FIG. 14, a semiconductor device 61 includes a diffusion layer 62, a polysilicon layer 63, and a shifter layer 64. As illustrated in FIG. 15, a gate 65 is located in a region where the diffusion layer 62 and the polysilicon layer 63 overlap in the semiconductor device 61. When a shape of a gate is verified, the gate 65 may be set as a graphic of the target layer, and the polysilicon layer 63 and the shifter layer 64 may be set as other layers related to the target layer.

In Embodiment 3, representative graphics of classes, which are obtained by multilayer grouping operations, are classified for each layer, grouping operations are performed for each layer, exposure simulations are performed for the representative graphics of the classes, which are obtained by performing the grouping operations for each layer, and the resultant graphics obtained by the simulations are superposed. A data verification device in Embodiment 3 may have the same configuration as the data verification device 31 in Embodiment 2.

Operations of the data verification device are described below.

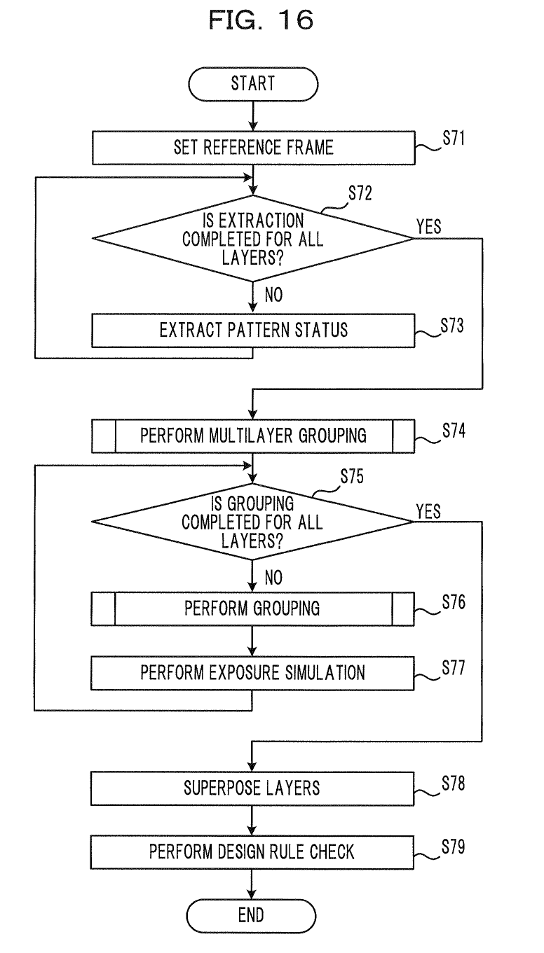

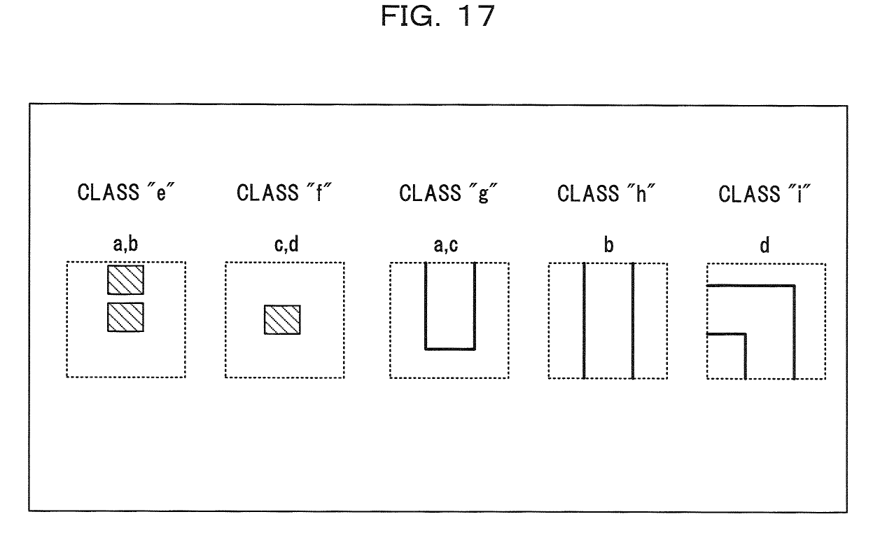

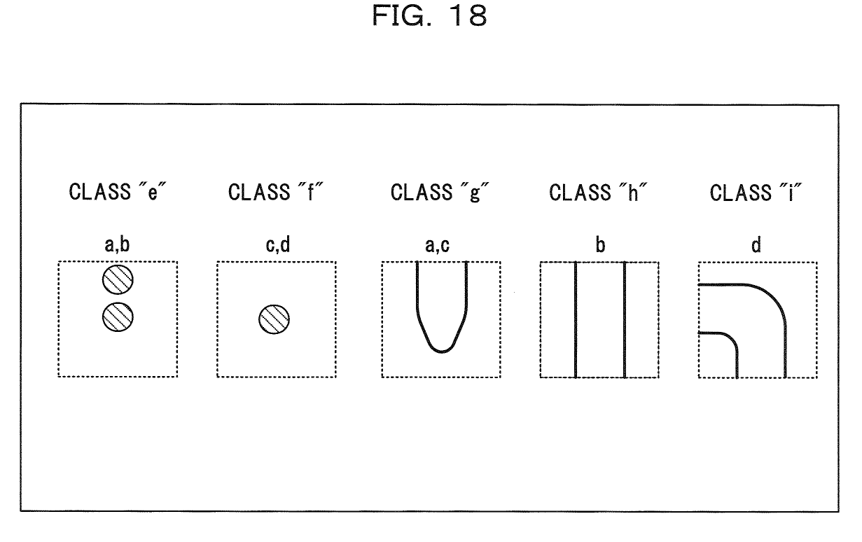

FIG. 16 is a flowchart illustrating Embodiment 3. FIGS. 17 and 18 illustrate an example according to Embodiment 3. In this example, a target layer is a contact layer and another layer related to the target layer is a wiring layer. In FIGS. 17 and 18, the rectangular frames indicated by dotted lines are reference frames, the shaded regions are included in the contact layer, and the regions in solid lines are included in the wiring layer.

As illustrated in FIG. 16, when data verifying operations start, similar to Operations S11 to S14 in FIG. 5 illustrating Embodiment 2, setting a reference frame (Operation S71), checking whether or not extraction of a pattern status is completed for all the layers (Operation S72), extracting the pattern status (Operation S73), and multilayer grouping (Operation S74) are sequentially performed. For example, similar to Embodiment 1, classes “a” to “d” as illustrated in FIG. 12 may be obtained by the multilayer grouping operations. For example, grouping information G1 may be obtained, which indicates that the class “a” includes a pattern status A (a representative graphic), that the class “b” includes a pattern status B (a representative graphic) and pattern statuses F and G, that the class “c” includes a pattern status C (a representative graphic) and a pattern status D, and that the class “d” includes a pattern status E (a representative graphic). Grouping information (for example, G1) obtained by the multilayer grouping operations includes contents of coordinate transforming operations by rotation and mirroring.

A layer classification part 35 classifies the representative graphics of the classes for each layer when the representative graphics are obtained by the multilayer grouping operations. When the grouping operations are uncompleted for any of the layers (Operation S75: No), a search part 36, a search information formation part 37, a matching part 39, a rotation and mirroring part 40, and a representative graphic extraction part 42 perform the grouping operations (Operation S76). The grouping operations are illustrated in FIGS. 6 and 7 for example. FIG. 17 illustrates classes “e” to “i” in which the classes “a” to “d” in FIG. 12 are grouped for each layer. The classes “e” and “f” are classes of the contact layer, and the classes “g,” “h,” and “i” are classes of the wiring layer. For example, grouping information G2 regarding the contact layer may be obtained, which indicates that the class “e” includes the class “a” (a representative graphic) and the class “b” and that the class “f” includes the class “c” (a representative graphic) and the class “d.” Also, for example, grouping information G3 regarding the wiring layer may be obtained, which indicates that the class “g” includes the class “a” (a representative graphic) and the class “c,” that the class “h” includes the class “b” (a representative graphic), and that the class “i” includes the class “d” (a representative graphic). The grouping information (for example, G2 and G3) obtained by the grouping operations performed based on the layer type includes the contents of the coordinate transforming operations by the rotation and the mirroring.

An exposure simulation part 43 performs exposure simulations for the representative graphics of each layer (Operation S77). FIG. 18 illustrates simulation patterns of the contact and wiring layers, which are obtained when the exposure simulations are performed for each layer. In the example illustrated in FIG. 18, the exposure simulations are performed for the representative graphics of the classes “e” to “i” for one time each, that is, for a total of five times. Although each of FIGS. 17 and 18 illustrates the contact layer and the wiring layer together, in the actual flow, the wiring layer undergoes the grouping operations and the exposure simulations after the contact layer undergoes the grouping operations and the exposure simulations.

When the grouping operations and the exposure simulations are completed for all layers (Operation S75: Yes), a superposition part 41 superposes the layers (Operation S78). Based on the grouping information G1, G2, and G3, for example, the simulation patterns of the contact layer and the simulation patterns of the wiring layer are superposed. The superposed simulation patterns are generated for the classes included in the grouping information G1, one for one. For example, when the simulation pattern of the class “b” illustrated in FIG. 12, which includes the pattern statuses B, F, and G, is generated, the class “e” is selected from the simulation patterns of the contact layer, and the class “h” is selected from the simulation patterns of the wiring layer (see FIG. 18). The simulation patterns of the classes “e” and “h” undergo the coordinate transforming operations so that the contents of the coordinate transforming operations included in the grouping information G2 and G3 are reversed, and are superposed based on the grouping information G1.

The DRC part 44 verifies the superposed simulation patterns by DRC (Operation S79). The output part 45 applies the verification result to the original circuit patterns by performing coordinate reverse-transforming operations for the verification result so that the coordinates obtained as the result of the coordinate reverse-transforming operations, which are included in the grouping information G1, are reversed in terms of coordinates. After that, the output part 45 outputs the result to an output device, such as a display, and the above operations are completed. The multilayer grouping operations, searching operations, multilayer matching operations, and single layer matching operations in Embodiment 3 are similar to those in Embodiment 2. According to Embodiment 3, advantages similar to those according to Embodiment 2 may be obtained.

Each of the data verification methods described in Embodiments 1 to 3 may be performed by executing a previously prepared program on a computer, such as a personal computer or a workstation. The program may be recorded in a recording medium readable with the computer, such as a hard disk, a flexible disk, a CD-ROM, an MO, or a DVD, and is executed by being read from the recording medium with the computer. Alternatively, the program may be a transmission medium distributable via a network, such as the Internet.

The data verification devices 1 and 31 described in Embodiments 1 to 3 may employ a Programmable Logic Device (PLD) for identifying a standard cell, a structured Application Specific Integrated Circuit (ASIC), such as an IC or a Field Programmable Grid Array (FPGA), and/or the like. For example, the data verification device 31 may be manufactured by defining the elements 32 to 45 of the data verification device 31 in a hardware description language (HDL) and logically synthesizing the HDL description to provide the ASIC or the PLD with the resultant description. The storage parts 51 to 58 of the data verification device 31 may be memories of the main computer.

According to the above-described embodiments, shapes of circuit patterns in two or more layers that are mutually related may be verified.

Although the embodiment of the present invention are numbered with, for example, “first,” “second,” or “third,” the ordinal numbers do not imply priorities of the embodiment. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A data verification method comprising:
extracting a first graphic included in a first reference frame set to correspond to a reference coordinate, and extracting a second graphic included in a second reference frame set to correspond to the reference coordinate, from a first circuit pattern;
extracting a third graphic included in the first reference frame and a fourth graphic included in the second reference frame from a second circuit pattern, the second circuit pattern being in a layer different than a layer including the first circuit pattern;
performing coordinate transformation on the first graphic;
comparing the first graphic having undergone the coordinate transformation with the second graphic;
performing the coordinate transformation on the third graphic;
comparing the third graphic having undergone the coordinate transformation with the fourth graphic;
when matching of the first graphic having undergone the coordinate transformation and the second graphic is determined, and matching of the third graphic having undergone the coordinate transformation and the fourth graphic is determined, performing grouping for the first and second graphics and setting the first graphic as a first representative graphic; and
verifying a shape of the first circuit pattern based on the first representative graphic.

2. The data verification method according to claim 1, comprising:
when the grouping is performed, combining the first graphic and the third graphic based on the first reference frame,
wherein a combined graphic is set as the first representative graphic.

3. The data verification method according to claim 1, comprising:
performing an exposure simulation on the first representative graphic, and
wherein the shape of the first circuit pattern is verified based on the exposure simulated first representative graphic.

4. The data verification method according to claim 1, comprising:
in the grouping, performing grouping for the third and fourth graphics and setting the third graphic as a second representative graphic;
performing an exposure simulation on each of the first representative graphic and the second representative graphic; and
combining the exposure simulated first and second representative graphics, and
wherein the shape of the first circuit pattern is verified based on the combined, exposure simulated first and second representative graphics.

5. The data verification method according to claim 4,
wherein, when the first and second representative graphics are combined, the first and second representative graphics are combined after the coordinate transformation of the first graphic is reversed and the coordinate transformation of the third graphic is reversed.

6. The data verification method according to claim 1,
wherein the first circuit pattern is a pattern in a contact layer and the second circuit pattern is a pattern in a wiring layer to which the contact layer is related.

7. A data verification device comprising:
an extraction part that extracts a first graphic included in a first reference frame set to correspond to a reference coordinate from a first circuit pattern, extracts a second graphic included in a second reference frame set to correspond to the reference coordinate from the first circuit pattern from a second circuit pattern, extracts a third graphic included in the first reference frame, and extracts a fourth graphic included in the second reference frame from the second circuit pattern, the second circuit pattern being in a layer different than a layer including the first circuit pattern;
a comparison part that performs coordinate transformation on the first graphic, compares the first graphic having undergone the coordinate transformation with the second graphic, performs the coordinate transformation on the third graphic, and compares the third graphic having undergone the coordinate transformation with the fourth graphic;
a grouping part that performs grouping for the first and second graphics and sets the first graphic as a first representative graphic when matching of the first graphic having undergone the coordinate transformation and the second graphic is determined, and when matching of the third graphic having undergone the coordinate transformation and the fourth graphic is determined; and
a verification part that verifies a shape of the first circuit pattern based on the first representative graphic.

8. The data verification device according to claim 7, further comprising:
a combining part that combines the first and third graphics based on the first reference frame when the grouping is performed,
wherein the grouping part sets a combined graphic as the first representative graphic.

9. The data verification device according to claim 7, further comprising:
an exposure simulation part that performs an exposure simulation on the first representative graphic, and
wherein the verification part verifies the shape of the first circuit pattern based on the exposure simulated first representative graphic.

10. The data verification device according to claim 7,
wherein the grouping part performs the grouping for the third and fourth graphics and sets the third graphic as a second representative graphic, the data verification device further comprising:
an exposure simulation part that performs an exposure simulation on each of the first and second representative graphics; and
a combining part that combines the exposure simulated first and second representative graphics, and
wherein the shape of the first circuit pattern is verified based on the combined, exposure simulated first and second representative graphics.

11. The data verification device according to claim 10,
wherein, when the combining part combines the first and second representative graphics, the combining part combines the first and second representative graphics after the coordinate transformation for the first graphic is reversed and the coordinate transformation for the third graphic is reversed.

12. A computer-readable recording medium storing a program, the program causing the computer to execute:
extracting a first graphic included in a first reference frame set to correspond to a reference coordinate and a second graphic included in a reference frame set to correspond to the reference coordinate, from a first circuit pattern;
extracting a third graphic included in the first reference frame and a fourth graphic included in the second reference frame from a second circuit pattern, the second circuit pattern being in a layer different than a layer including the first circuit pattern;
performing coordinate transformation on the first graphic;
comparing the first graphic having undergone the coordinate transformation with the second graphic;
performing the coordinate transformation on the third graphic;
comparing the third graphic having undergone the coordinate transformation with the fourth graphic;
performing grouping for the first and second graphics and setting the first graphic as a first representative graphic when matching of the first graphic having undergone the coordinate transformation and the second graphic is determined, and matching of the third graphic having undergone the coordinate transformation and the fourth graphic is determined; and
verifying a shape of the first circuit pattern based on the first representative graphic.

13. The computer-readable recording medium according to claim 12, the program causing the computer to further execute:
when the grouping is performed, combining the first and third graphics based on the first reference frame, and
wherein a combined graphic is set as the first representative graphic.

14. The computer-readable recording medium according to claim 12, the program causing the computer to further execute:
performing an exposure simulation on the first representative graphic, and
wherein the shape of the first circuit pattern is verified based on the exposure simulated first representative graphic.

15. The computer-readable recording medium according to claim 12, the program causing the computer to further execute:
when the grouping is performed, performing grouping for the third and fourth graphics and setting the third graphic as a second representative graphic,
performing an exposure simulation on each of the first and second representative graphics; and
combining the exposure simulated first and second representative graphics, and
wherein the shape of the first circuit pattern is verified based on the combined, exposure simulated first and second representative graphics.

16. The computer-readable recording medium according to claim 15,
wherein, when the first and second representative graphics are combined, the first and second representative graphics are combined after the coordinate transformation for the first graphic is reversed and the coordinate transformation for the third graphic is reversed.

17. The computer-readable recording medium according to claim 12,
wherein the first circuit pattern is a pattern in a contact layer and the second circuit pattern is a pattern in a wiring layer to which the contact layer is related.
